(19) United States
(12) Patent Application Publication
(10) Pub. No.: US 2016/0320954 A1
(43) Pub. Date: Nov. 3, 2016

(54) ONE-TOUCH REPLAY FOR WHITEBOARD

(71) Applicant: Elwha LLC, Bellevue, WA (US)

(72) Inventors: Michael Angiulo, Redmond, WA (US); Brett D. Brewer, Sammamish, WA (US); Jesse R. Cheatham, III, Seattle, WA (US); William Gates, Medina, WA (US); Jefferson Y. Han, Bellevue, WA (US); Roderick A. Hyde, Redmond, WA (US); Muriel Y. Ishikawa, Livermore, CA (US); Edward K.Y. Jung, Bellevue, WA (US); Jordin T. Kare, San Jose, CA (US); Max N. Mankin, Cambridge, MA (US); Vijay Mital, Kirkland, WA (US); Nathan P. Myhrvold, Medina, WA (US); Patrick Neill, Sammamish, WA (US); Amir Netz, Bellevue, WA (US); Tony S. Pan, Bellevue, WA (US); Robert C. Petroski, Seattle, WA (US); Eric D. Rudder, Mercer Island, WA (US); David R. Smith, Durham, NC (US); Clarence T. Tegreene, Mercer Island, WA (US); David L. Tennenhouse, Hillsborough, CA (US); Charles Whitmer, North Bend, WA (US); Lowell L. Wood, JR., Bellevue, WA (US); Victoria Y.H. Wood, Livermore, CA (US)

(73) Assignee: Elwha LLC, Bellevue, WA (US)

(21) Appl. No.: 14/700,648

(22) Filed: Apr. 30, 2015

(51) Int. Cl. G06F 3/0484; G06F 3/0488

(52) U.S. Cl. CPC G06F 3/04847; G06F 3/04883; G06F 3/04842; G06F 3/04845

(57) ABSTRACT

Systems, methods, and apparatuses for displaying items based on time data, such as time of entry, include use of a display device configured to display items, and a processing circuit configured to control operation of the display device and modify characteristics associated with the items. An input, such as a touch, may be used to guide display of the items, including presenting the items in a replay format.

### BACKGROUND

Display devices such as electronic whiteboards are used to store and present information for various purposes. Information may be provided to display devices directly, such as by manual input by touch or a handheld device. Information may be provided to display devices indirectly, such as through a personal electronic device.

### SUMMARY

One embodiment relates to a display system. The display system includes a display device configured to display a first item based on receiving a first input and display a second item based on receiving a second input. The display system also includes a processing circuit configured to store first time data corresponding to a first time of receipt of the first input. The processing circuit is also configured to store second time data corresponding to a second time of receipt of the second input. The processing circuit is also configured to receive a third input identifying at least one of the first display item and the second display item. The processing circuit is also configured to change a display characteristic of at least one of the first display item and the second display item based on the third input, the first time data, and the second time data.

Another embodiment relates to a display system. The display system includes a display device configured to display a plurality of display items, and a processing circuit. The processing circuit is configured to store time data regarding a display time for each of the plurality of display items, receive an input identifying a selected display item from one of the plurality of display items, and change a display characteristic of at least one of the plurality of display items based on the input and the time data.

Another embodiment relates to a display system. The display system includes a display device configured to display a plurality of display items, and a processing circuit. The processing circuit is configured to store time data regarding a display time for each of the plurality of display items, receive an input identifying a selected display item from one of the plurality of display items, and control operation of the display device to selectively display a portion of the plurality of display items in a time-based order based on the input and the time data.

Another embodiment relates to a method of displaying items on a display assembly. The method includes a displaying step in which a first display item is displayed based on receiving a first input at a first time. The method includes a displaying step in which a second display item is displayed based on receiving a second input at a second time. The method includes a receiving step in which a third input identifying at least one of the first display item and the second display item is received. The method includes a changing step in which a display characteristic of at least one of the first display item and the second display item is changed based on the third input, the first time, and the second time.

Another embodiment relates to a method of displaying a plurality of items on a display assembly. The method includes a storing step in which time data regarding a display time for each of the plurality of display items is stored. The method includes a receiving step in which an input identifying a selected display item from one of the plurality of display items is received. The method includes a changing step in which a display characteristic for each of the plurality of display items is selectively changed based on a comparison of the display time for the selected display item with the display time for each of the plurality of display items.

Another embodiment relates to a method of displaying a plurality of items on a display assembly. The method includes a storing step in which time data regarding a display time for each of the plurality of display items is stored. The method includes a receiving step in which an input identifying a selected display item from one of the plurality of display items is received. The method includes a displaying step in which a portion of the plurality of items is displayed in a time-based order based on the input and the time data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram of a display system in accordance with one embodiment.

FIG. 2 is a schematic diagram of a control system for controlling operation of a display device in accordance with one embodiment.

FIGS. 3A-3B illustrate manipulation of a display characteristic of a display item in accordance with one embodiment.

FIGS. 4A-4C illustrate manipulation of a display characteristic of a display item in accordance with one embodiment.

FIG. 5 illustrates various displays of time data for display items in accordance with various embodiments.

FIG. 6 illustrates manipulation of a display characteristic of a display item in accordance with one embodiment.

FIG. 7 illustrates a display characteristic of a display item in accordance with one embodiment.

FIG. 8 illustrates a personal electronic device having an interactive user interface in accordance with one embodiment.

FIG. 9 is a schematic diagram of display plan factors for a display plan in accordance with one embodiment.

FIG. 10 is a detailed view of the personal electronic device of FIG. 8.

FIG. 11 is a detailed view of a display device having an interactive user interface in accordance with one embodiment.

FIGS. 12A-12B illustrate manipulation of a display characteristic of a plurality of display items in accordance with one embodiment.

FIGS. 13A-13F illustrate various stages of a replay of display items in accordance with various embodiments.

FIGS. 14A-14E illustrate various stages of a reverse replay of display items in accordance with various embodiments.

FIG. 15 is a block diagram of a method of displaying items on a display assembly in accordance with one embodiment.

FIG. 16 is a block diagram of a method of displaying items on a display assembly in accordance with one embodiment.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring to the figures generally, various embodiments disclosed herein relate to apparatuses, methods, and systems of displaying display items on a display device or display assembly. Display items have corresponding time data, and may have associated display characteristics including but not limited to color, size, position, brightness, and visibility. A processing circuit is configured to receive an input regarding the display items and modify how display items are displayed, and may be configured to receive a display plan including the display characteristics, to modify display characteristics of display items based on the input and the time data, to receive a replay plan regarding displaying display items in a time-based order, and to display the display items in a time-based order, such as a fast-forwarded replay of all display items related to a display item selected by the input.

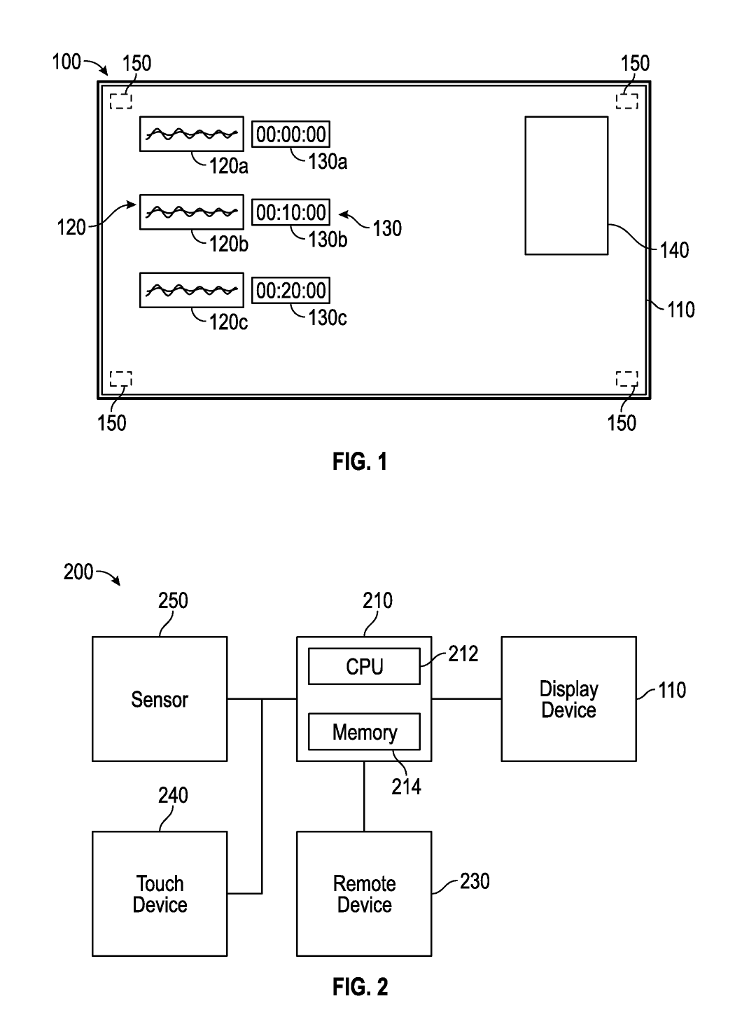

Referring to FIG. 1, in some embodiments, display system 100 includes display device 110, which displays display items 120 and user interface 140. First display item 120a has associated first display time note 130a; second display item 120b has associated second display time note 130b; third display item 120c has associated third display time note 130c. Display times notes 130a-130c may be displayed based on time data stored by a processing circuit (e.g. processing circuit 210 shown in FIG. 2).

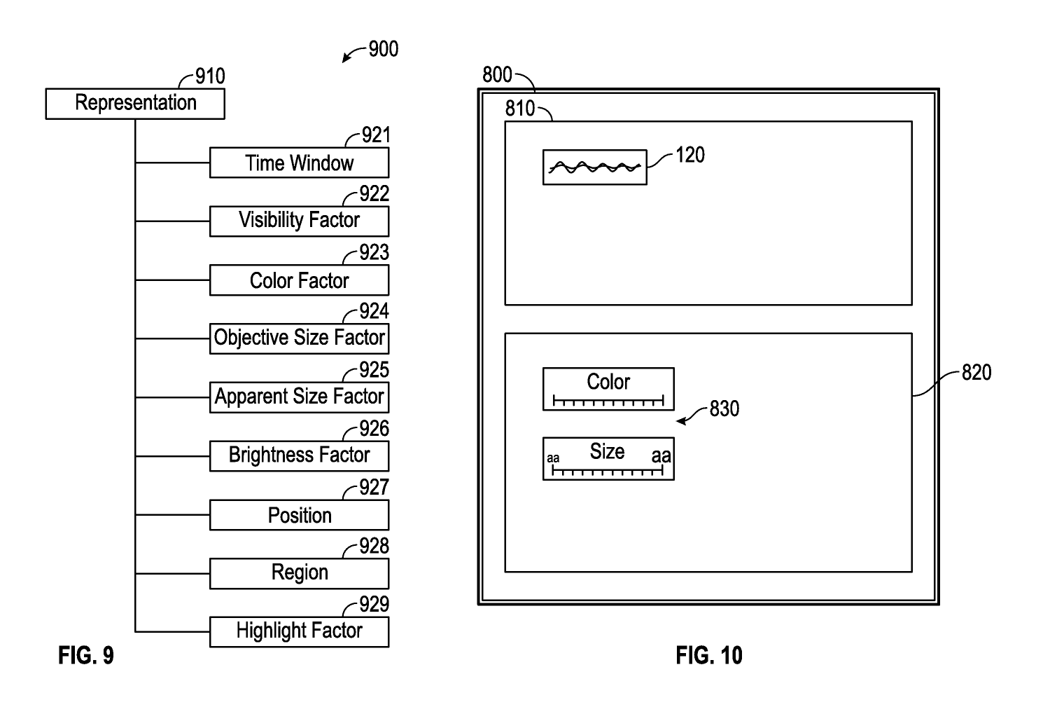

Display items 120 may be any form of visual information. Display items 120 may include text in any language; images; symbols; graphics; charts; figures; or any other such information. Display items 120 may be received having display characteristics (e.g. size, color, font, etc.). Display characteristics may be stored along with display items 120. Display characteristics may include or be related to a variety of features, including but not limited to features related to a display plan (e.g., display plan 900, time window 921, visibility factor 922, color factor 923, objective size factor 924, apparent size factor 925, brightness factor 926, position state 927, region state 928, highlight factor 929, etc., as shown in FIG. 9).

Time data, including display time notes 130, may be any temporal data relating to display items 120, such as times of entry; relative times of entry; times associated with operation of display system 100 such as when display system 100 is turned on, initialized, restarted, etc.; times associated with modification of display items 120; times associated with schedules, calendars, or events; or any other time data. For example, in some embodiments, time data may include a relative time of entry for first display item 120a relative to time of entry of second display item 120b, and a time corresponding to when display items 120 are modified. In some embodiments, display time note 130 is a visual instantiation of time data stored by processing circuit 210. In some embodiments, display time notes 130 are not displayed, but the underlying time data is still stored by processing circuit 210.

In some embodiments, display system 100 includes input sensor 150 configured to receive an input. Inputs may include direct inputs, such as manual touches including touches by fingers or other body parts; assisted touches, such as touches by pens, styluses, or other handheld implements; as well as indirect inputs, such as audio inputs, light-based inputs (e g infrared, laser, visible light, radio, etc.), and electronic inputs (e.g. from a personal electronic device such as personal electronic device 800, etc.). Inputs may include information configured to be displayed as display items 120. In some embodiments, the input is a visual signal including at least one of a light pointed at display device 110, a laser pointed at display device 110, a gesture, and a gaze. Input sensor 150 may be provided on the outside of display device 110 in order to facilitate visual communication with input sources; input sensor may be provided within display device 110 and be configured to communicate without using line-of-sight communication. Input sensors 150 may cover all or a portion of display device 110, and may be arranged in any suitable configuration.

User interface 140 may provide a plurality of selectable display options 160 and controls allowing for manipulation of display system 100. User interface 140 may display a plurality of selectable display options 160 relating to a display plan for storing display characteristics regarding display items 120 (e.g. display plan 900 shown in FIG. 9). A plurality of users may maintain and manipulate a plurality of display profiles associated with each user.

Referring to FIG. 2, control system 200 is shown for controlling operation of a display system such as display system 100. Control system 200 includes processing circuit 210, display device 110, remote device 230, touch device 240, and sensor 250. Processing circuit 210 includes central processing unit 212 and memory device 214. In some embodiments, control system 200 is implemented on display device 110. In some embodiments, one or more components of control system 200 is implemented remotely from display device 110.

Central processing unit 212 may be implemented as a general-purpose processor, an application specific integrated circuit (ASIC), one or more field programmable gate arrays (FPGAs), a digital-signal-processor (DSP), a group of processing components, or other suitable electronic processing components. Memory 214 is one or more devices (e.g., RAM, ROM, Flash Memory, hard disk storage, etc.) for storing data and/or computer code for facilitating the various processes described herein. Memory 214 may be or include non-transient volatile memory or non-volatile memory. Memory 214 may include database components, object code components, script components, or any other type of information structure for supporting the various activities and information structures described herein. Memory 214 may be communicably connected to central processing unit 212 and provide computer code or instructions to central processing unit 212 for executing the processes described herein.

In some embodiments, processing circuit 210 is configured to receive user inputs in order to control operation of display device 110 to display display items 120. User inputs may include display items 120. Processing circuit 210 may be configured to store display items 120 and information associated with display items 120, such as time data, in memory 214. Processing circuit 210 may be configured to manipulate a display plan (e.g. display plan 900 shown in FIG. 9) based on inputs.

In some embodiments, display device 110 is configured to display first display item 120a based on receiving a first input and display second display item 120b based on receiving a second input. Processing circuit 210 is configured to store time data corresponding to a first time of receipt of the first input, store second time data corresponding to a second time of receipt of the second input, receive a third input identifying at least one of first display item 120a and second display item 120b, and change a display characteristic of at least one of first display item 120a and second display item 120b based on the third input, the first time data, and the second time data. For example, a user may provide first display item 120a and second display item 120b, and display device 110 may display display items 120a-120b. A user may then provide a third input identifying first display item 120a and directing processing circuit 210 to change a display characteristic of second display item 120b such as a brightness factor (e.g. brightness factor 926 shown in FIG. 9). Upon receipt of the third input identifying first display item 120a, processing circuit 210 designates the first time of receipt as a target time. Processing circuit 210 can be configured to change a display characteristic of second display item 120b based on a relationship between the target time and the second time of receipt. In one embodiment, processing circuit 210 can determine the time difference between the target time and the second time of receipt, and can change a display characteristic of second display item 120b based on this time difference (e.g., based upon its magnitude, its sign, etc.). In one embodiment, a user may provide a third input directing processing circuit 210 to set brightness factor 926 of second display item 120b to a dim state if the second time of receipt of the second input occurred prior to the target time.

In some embodiments, remote device 230 is configured to provide remote data to processing circuit 210. Remote data may include an input, a display plan (e.g. display plan 900 shown in FIG. 9), a replay plan, or any other data for displaying display items 120. Remote device 230 may include a personal electronic device (e.g. personal electronic device 800 shown in FIG. 8). In some embodiments, sensor 250 is configured to receive data including but not limited to remote data and data transmitted by devices such as remote device 230 or touch device 240. Sensor 250 may include input sensors 150.

In some embodiments, processing circuit 210 is configured to determine a time difference based on a first time of receipt of first display item 120a and a second time of receipt of second display item 120b. The time difference may be stored as a relative difference which includes an indication of which of the first time of receipt and the second time of receipt occurred first. For example, a relative time difference may include a positive sign if the second time of receipt occurred after the first time of receipt, and may include a negative sign if the second time of receipt occurred before the first time of receipt. Alternatively, the time difference may be stored as an absolute difference, in which no indication of which time of receipt occurred first is included.

The first time of receipt and the second time of receipt may be stored as a value accurate to any unit of time, and the time difference may be correspondingly stored as a value accurate to any unit of time (e.g. units larger than minutes, minutes, seconds, units smaller than seconds, etc.). The stored value of the time difference may be used in any subsequent calculations, or the time difference may be rounded, or the time difference may be truncated to a floor value or a ceiling value based on a less accurate unit of time. For example, the time difference may be stored as 101.0001 seconds, and may be used as 101 seconds for any subsequent calculations.

Processing circuit 210 may be configured to change a display characteristic of first display item 120a based on the time difference and a predetermined time window. The predetermined time window may be a default time window, a user-inputted time window, a display characteristic of a display plan (e.g. time window 921 of display plan 900 shown in FIG. 9), etc.

Time window 921 may be an absolute value or a relative value, and may be accurate to any unit of time (e.g. units larger than minutes, minutes, seconds, units smaller than seconds, etc.). For example, in one embodiment, the time window may be an absolute value of 10 seconds, in which case processing circuit 210 may be configured to change a display characteristic of first display item 120a if the time difference (e.g., between the target time and the second display time) is between negative 10 seconds and positive 10 seconds. In another embodiment, the time window may be a relative value of positive 10 seconds, in which case processing circuit 210 may be configured to change a display characteristic of first display item 120a if the time difference is between zero and 10 seconds, but not if the time difference is between −10 and zero seconds.

The stored value of time window 921 may be used in any subsequent calculations, or time window 921 may be rounded, or time window 921 may be truncated to a floor value or a ceiling value based on a less accurate unit of time. For example, time window 921 may be stored as 101.0001, and may be used as 101 for any subsequent calculations. Processing circuit 210 may be configured to change display characteristics of first display items 120 depending on the sign of time window 921.

In one embodiment, time window 921 is an absolute value, and processing circuit 210 is configured change the display characteristics of display items 120 such that any display item 120 with a time of entry outside of time window 921 relative to the target time (e.g., to the first time of entry of first display item 120a) is erased. For example, processing circuit 210 may be configured to compare time window 921 to a time difference. If processing circuit 210 determines the time difference to be greater than time window 921, processing circuit 210 changes the visibility factor display characteristic (e.g., visibility factor 922 shown in FIG. 9) of second display item 120b such that second display item 120b has its visibility factor 922 set to an invisible state.

In some embodiments, time window 921 can be combined with the target time to form a time interval. In one embodiment, the time interval extends from a lower time value corresponding to the target time minus the duration of the time window up to an upper time value corresponding to the target time; i.e., the time interval has the same duration as that of the time window, but starts before the target time and ends at the target time. In one embodiment, the time interval extends from a lower time value corresponding to the target time up to an upper time value corresponding to the target time plus the duration of the time window; i.e., the time interval has the same duration as that of the time window, but starts at the target time and ends after the target time. In another embodiment, the time interval has the same duration as the time window, but straddles the target time; i.e., it starts before the target time and ends after the target time (e.g., the time interval may be centered on the target time). In other embodiments, the duration of the time interval may be less than that of the time window so as to constrain the lower time value or the upper time value to specified limits, e.g., so that the lower time value is no earlier than the start of a usage session, the upper time value is no later than the end of a usage session, etc. Processing circuit 210 can be configured to change a display characteristic of second display item 120b based on whether or not the second display time is inside or outside of the time interval. For example, if the second display time is inside the time interval, the color of second display item 120b can be set to green (e.g., color factor 923 can be set to a green state, etc.), If the second display time is outside the time interval, the color of second display item 120b can be set to red (e.g., color factor 923 can be set to a red state); similarly, other changes can be made to illustrate the relationship between the second display time and the time interval (e.g., second display item 120b can be dimmed by setting brightness factor 926 to a dim state; second display item 120b can be made invisible by setting visibility factor to an invisible state, etc.).

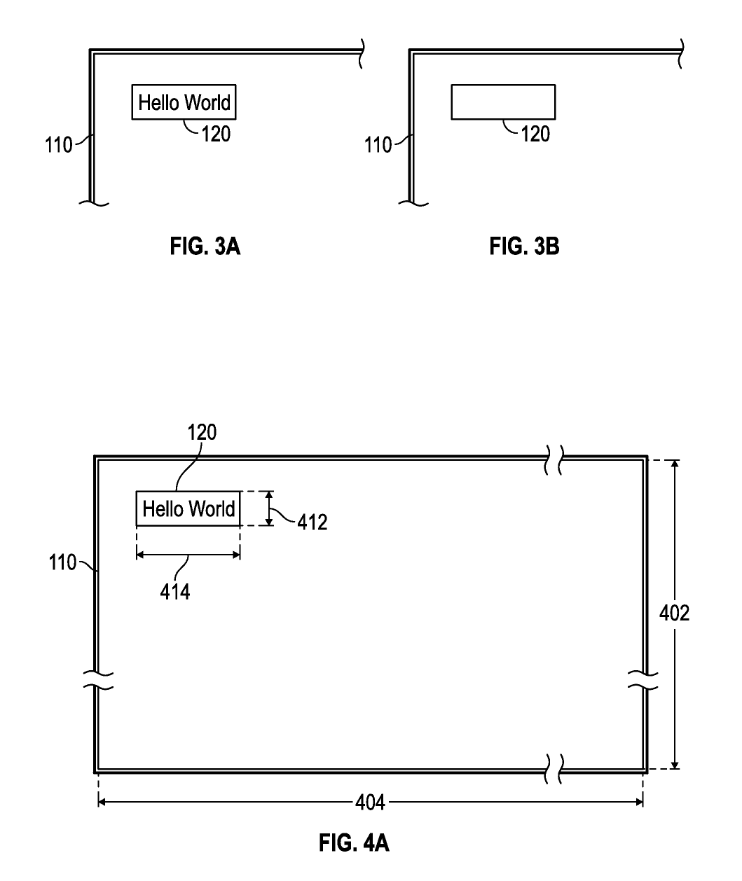

Referring to FIGS. 3A-3B, in some embodiments, display characteristics of display items 120 include a visibility factor (e.g. visibility factor 922 shown in FIG. 9). Visibility factor 922 may include a visible state and an invisible (i.e. “erased”) state. For example, FIG. 3A illustrates display item 120 displayed on display device 110 in a visible state. FIG. 3B illustrates display item 120 displayed on display device 110 in an invisible state. Visibility factor 922 may be controlled by any number of methods for modifying visibility of information on a display, such as by changing a color factor (e.g. color factor 923) of display item 120 to match the background color of display device 110. For example, a user may provide an input to erase display item 120 by making it invisible on display device 110 having a white background. In response to the input, processing circuit 210 may be configured to change color factor 923 to white. In some embodiments, processing circuit 210 is configured to discontinue storage of data regarding display items 120 after display items 120 have had visibility factor 922 set to an invisible state. In some embodiments, processing circuit 210 is configured to continue to store data regarding display items 120 after display items 120 have had visibility factor 922 set to an invisible state.

In some embodiments, display characteristics of display items 120 include a color factor (e.g., color factor 923 shown in FIG. 9). Color factor 923 may include at least one of a red state, a blue state, and a green state. In some embodiments, display device 110 is configured to display display items 120 in a variety of other colors (e.g. white, black, yellow, etc.) using a color model such as an RGB color model and composing a mix of red, blue, and green colors. Other colors may be used according to various alternative embodiments.

In some embodiments, each of the red state, blue state, and green state correspond to specific qualities of display items 120. For example, a red state may correspond to any display items 120 having a time of entry preceding the first time of entry of first display item 120a, a blue state may correspond to first display item 120a, and a green state may correspond to any display items having a time of entry following the first time of entry of first display item 120a.

In some embodiments, display characteristics of display items 120 include a brightness factor (e.g. brightness factor 926 shown in FIG. 9). Brightness factor 926 may include at least one of a dim state, a normal brightness state, and a bright state. The normal brightness state may be a default state of display device 110, or may be the brightness of display item 120 when display item 120 was received by display device 110. The dim state may correspond to an absolute brightness level (e.g., based on a measure of light intensity such as luminous intensity), or may be a relative brightness level relative to the brightness of the normal brightness state. The bright state may correspond to an absolute brightness level (e.g., based on a measure of light intensity such as luminous intensity), or may be a relative brightness level relative to the brightness of the normal brightness state. In some embodiments, brightness factor 926 can include a time varying brightness, such as blinking, oscillating, increasing, decreasing, etc.

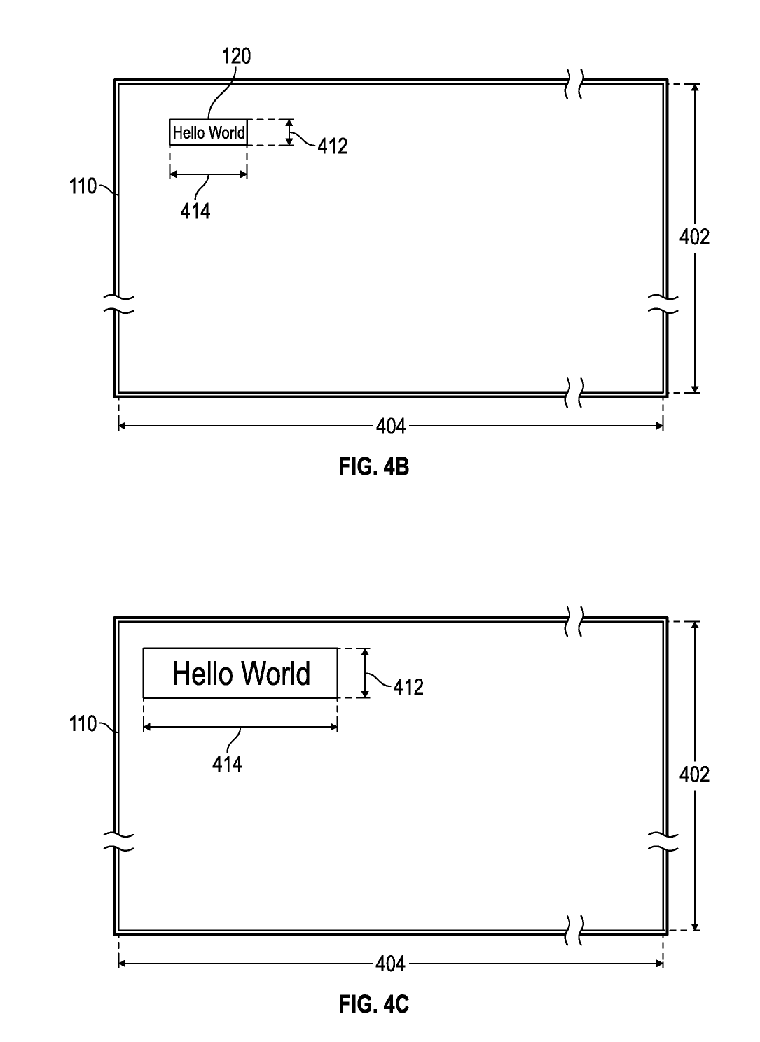

Referring to FIGS. 4A-4C, in some embodiments, display characteristics of display items 120 include an objective size factor (e.g. objective size factor 924 shown in FIG. 9). Objective size factor 924 reflects the space on display device 110 occupied by display item 120. In some embodiments, display device 110 defines height 402 and length 404, and display item 120 defines display item height 412 and display item length 414. Objective size factor 924 may then be determined based on the absolute values of height 402, length 404, display item height 412, and display item length 414, as well as the relationships amongst these values. In some embodiments, objective size factor 924 includes an aspect ratio, such as a ratio of display item height 412 to display item length 414.

Referring to FIG. 4A, display item 120 is shown with its objective size factor 924 set to a normal objective size state. Objective size factor 924 may be determined relative to an objective size of display item 120 when it was initially received by a display system such as display system 100 including display device 110, or when display item 120 was initially stored by a processing circuit such as processing circuit 210, etc. For example, display item 120 may have a normal objective size state when display item height 412 and display item length 414 are identical to when display item 120 was initially received.

Referring to FIG. 4B, display item 120 is shown with objective size factor 924 set to a small objective size state. Display item 120 may have a small objective size state when at least one of display item height 412 and display item length 414 are less than their initial values (i.e. less than their values when in a normal objective size state). In some embodiments, the small objective size state may reflect a specific size ratio relative to the normal objective size state (e.g. 10% size relative to normal objective size state, 50% size relative to normal objective size state, 90% size relative to normal objective size state, etc.). In some embodiments, the small objective size state is based on having a smaller size relative to the normal objective size state, while maintaining the same aspect ratio as the normal objective size state.

Referring to FIG. 4C, display item 120 is shown with objective size factor 924 set to a large objective size state. Display item 120 may have a large objective size state when at least one of display item height 412 and display item length 414 are greater than their initial values (i.e. greater than their values when in a normal objective size state). In some embodiments, the large objective size state may reflect a specific size ratio relative to the normal objective size state (e.g. 150% size relative to normal objective size state, 200% size relative to normal objective size state, etc.). In some embodiments, the large objective size state is based on having a larger size relative to the normal objective size state, while maintaining the same aspect ratio as the normal objective size state. Objective size may be varied to reflect a time of entry, such that earlier entries are smaller and larger entries are larger.

In some embodiments, display characteristics of display item 120 include an apparent size factor (e.g. apparent size factor 925 shown in FIG. 9). Apparent size factor 925 may include at least one of a small apparent size state, a normal apparent size state, and a large apparent size state. Apparent size factor 925 includes data regarding how to display display items 120 in a manner other than direct viewing by eyes, cameras, or reproduction of the display items 120 on display device 110. For example, in some embodiments, display device 110 may be configured to display display items 120 in a three-dimensional format (e.g. stereoscopic display, autostereoscopic display, etc.). Apparent size factor 925 may reflect display of display items 120 such that display items 120 appear to be a different size than objective size factor 924 (which is not affected by changes to apparent size factor 925). For example, display item 120 may have its apparent size factor 925 in a large apparent size state, such that when viewed in a three-dimensional format, display item 120 appears to be larger than when viewed in a standard (i.e. non-three-dimensional) format. For example, apparent size factor 925 can control the apparent height (i.e., protrusion out of a 2-D display surface) or the apparent depth (i.e., retraction into a 2-D display surface) of display item 120 when it is displayed in a three-dimensional format.

In some embodiments, display characteristics of display item 120 include highlighting factors to increase or decrease a user's awareness of display item 120 (e.g., highlight factor 929 shown in FIG. 9). Highlight factor 929 can include the background of display item 120, e.g., using a yellow background to enhance the user's awareness. For embodiments where display item 120 includes text, highlight factor 929 can include the type of font used, making the text bold or not, making the text italicized or not, etc. For embodiments where display item 120 includes symbols such as lines, boxes, or the like, highlight factor 929 can include how symbol lines borders are displayed (e.g. their width, whether they are solid or use dot or dash patterns), whether or how symbol interiors are shaded, etc.

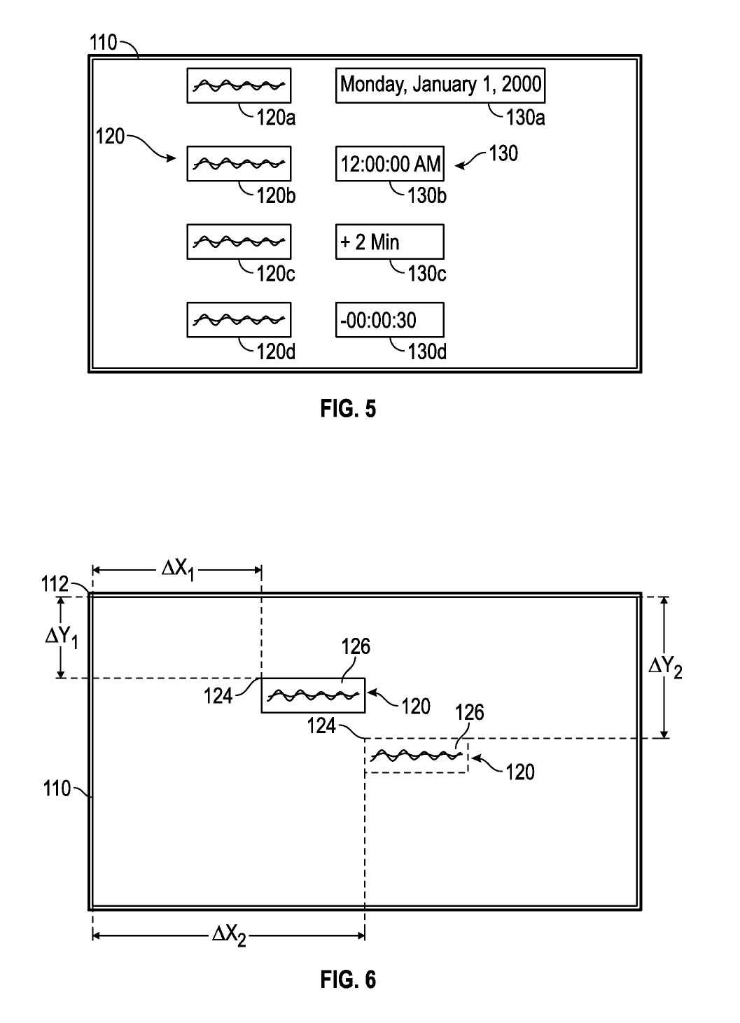

Referring to FIG. 5, various embodiments of display time notes 130 associated with display items 120 displayed on display device 110 are shown. In accordance with one embodiment, display time note 130a is shown as a calendar date, such as in a format providing at least one of the day of the week, the month, the day of the month, and the year. In accordance with one embodiment, display time note 130b is shown as a specific time of day, including at least one of the hour, the minute, the second, and an indication of A.M. time or P.M. time.

In some embodiments, display time notes 130 are shown as relative times. For example, display time note 130c is shown as a time difference in minutes with a positive sign, relative to a different time of entry of different display item 120. In some embodiments, the time difference is shown in a format rounded to the nearest time demarcation (e.g. rounded to the nearest second, nearest minute, nearest hour, etc.). In accordance with one embodiment, display time note 130d is shown having a time difference in a detailed format, including hours, seconds, and minutes. In some embodiments, display item notes 130 are not displayed, even if time data associated with display item notes 130 remains stored by processing circuit 210.

Referring to FIG. 6, display system 100 is shown including display device 110 with display items 120, and display items 120 have display characteristics including a position state (e.g. position state 927 shown in FIG. 9). Position state 927 may include data such as display item position 124 shown in FIG. 6. Position state 927 may be established in any coordinate system applicable to display system 100, including but not limited to a Cartesian x-y-z coordinate system with distances in each dimension based on any origin point used by display system 100, or a cylindrical r-z-O coordinate system with radial distances, vertical distances, and angles swept based on any origin point used by display system 100. In some embodiments, display device 110 has a substantially planar shape, and two dimensions may be used to represent position state 927. In some embodiments, display device 110 has a three-dimensional shape, or display device 110 is configured to display display items 120 in three dimensions, and three dimensions may be used to represent position state 927.

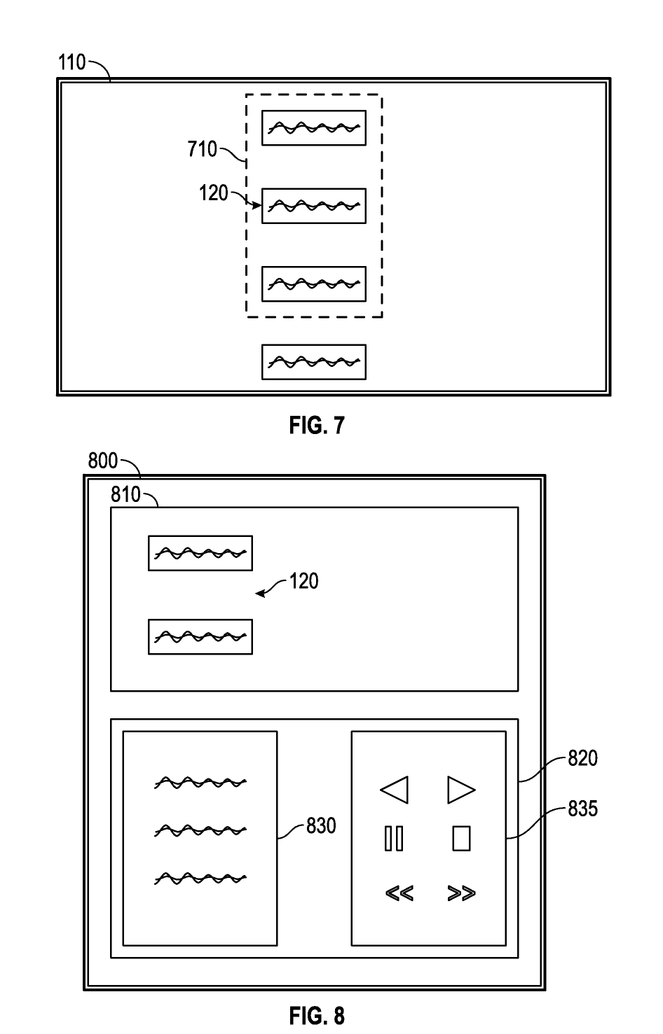

Position state 927 for display item 120 may be determined based on any position in the coordinate system associated with display item 120. For example, as shown in FIG. 6, display item 120 defines display item position 124. Display item position 124 may coincide with at least part of written/visual information which display item 120 includes; or may be offset by some distance from written/visual information which display item 120 includes; or may be associated with a region (e.g. region 710 shown in FIG. 7) surrounding display item 120; etc. Display item position 124 may coincide with bounding box 126 for marking boundaries of display item 120. Bounding box 126 may be visible or invisible.

Referring further to FIG. 6, in some embodiments, display device 110 includes origin 112. Position state 927 includes first horizontal offset Δx₁ from origin 112, and first vertical offset Δy₁ from origin 112. In some embodiments, processing circuit 210 is configured to change position state 927 of display item 120 based on an input, such that position state 927 of display item 120 is shifted based on second horizontal offset Δx₂ from origin 112 and second vertical offset Δy₂ from origin 112. In some embodiments, an input may direct processing circuit 120 to arrange display items 120 in an order reflecting times of entry of display items 120. For example, display items 120 may be arranged left-to-right, top-to-bottom, outside-to-inside, etc., beginning with display item 120 having an earliest time of entry and ending with display item 120 having a latest time of entry. In some embodiments, the input may include new display item 120, and processing circuit 210 may modify position states 927 of existing display items 120 to create space for new display item on display device 110. In some embodiments, the input may direct processing circuit 210 to erase a subset of display items 120 by setting visibility state 922 of display items 120 to an invisible state, and may further direct processing circuit 210 to modify position states 927 of remaining display items 120 to shift remaining display items 120 into a more compact arrangement covering space previously covered by the currently invisible subset of display items 120.

Referring to FIG. 7, in some embodiments, display characteristics of display item 120 include region 710. Region 710 may be any region including at least some part of display item 120. Region 710 may include multiple display items 120. Region 710 may be a shape including all of display item 120 (e.g. rectangle, circle, etc.). Region 710 may be a free-form region including all of display item 120. Region 710 may be defined by a set distance from any part of display item 120. Region 710 may be a line or curve dividing display device 110. Region 710 may be marked by a visible indicator (e.g. solid line, dotted line, dashed line, etc.), or may be invisible. Region 710 may at least partially coincide with bounding box 126. In some embodiments, processing circuit 210 is configured to define region 710 based on an input. For example, a user may provide an input by drawing an open or closed line or curve around display item 120, and processing circuit 210 may be configured to define region 710 based on the line or curve. For example, a set of display items 120 which satisfy a display selection criteria (e.g., whose display times lie within a specified time interval) can define region 710, and can be enclosed within a visible border.

Referring to FIG. 8, in some embodiments, personal electronic device 800 is configured to interact with display system 100 and/or control system 200. Personal electronic device 800 may be configured to reproduce all display items 120 and associated information (e.g. display time notes 130, display characteristics, etc.) displayed on display device 110. Personal electronic device 800 may be configured to display less than all display items 120 and associated information displayed on display device 110, such as a selection of display items 120 and associated information. In some embodiments, personal electronic device 800 is configured to mirror the display format of display items 120. In some embodiments, electronic device 800 is configured to display display items 120 in a modified format, so as to facilitate viewing and manipulation on personal electronic device 800 of display items 120.

In some embodiments, personal electronic device 800 is configured to display user interface 820 including a plurality of selectable display plan options 830 regarding a display plan (e.g. display plan 900 shown in FIG. 9). Display plan options 830 may provide a user with a variety of authorization levels for modifying display plan characteristics included in display plan 900. For example, personal electronic device 800 may be configured to allow a first user to modify any display characteristic of every display item 120, and may be further configured to allow a second user to only modify specific display characteristics of specific display items 120. In some embodiments, personal electronic device 800 includes a touchscreen, and a user may manipulate items displayed on personal electronic device 800 including display plan options 830 using the touchscreen. For example, personal electronic device 800 may display a visual representation of display device 110 on the touchscreen, and the input may be a touch on the visual representation.

Referring to FIG. 9, in some embodiments, processing circuit 210 is configured to control display of display items 120 based on display plan 900. Display plan 900 may include representation 910 of display item 120. Representation 910 may be an exact copy of display item 120, or may be a modified version of display item 120 configured to facilitate storage of display item 120 in display plan 900. Display plan 900 may include various display characteristics, such as time window 921, visibility factor 922, color factor 923, objective size factor 924, apparent size factor 925, brightness factor 926, position state 927, region state 928, and highlight factor 929. Position state 927 may be a copy of, a modified version of, or otherwise related to display item position 124. Region state 928 may be a copy of, a modified version of, or otherwise related to region 710.

Processing circuit 210 may be configured to modify display plan 900 in response to an input, or in response to manipulation of selectable display plan options 830 through a user interface such as user interface 140 or user interface 820, etc. Display plan 900 may include default settings for each display characteristic. In some embodiments, different levels of authorization may be required to access or modify certain display characteristics. For example, a user lacking a high level of authorization may be unable to modify visibility factor 922 of display plan 900.

Referring to FIG. 10, user interface 820 and display 810 of display items 120 are shown on personal electronic device 800 in accordance with one embodiment. In some embodiments, personal electronic device 800 is configured to enable a user to modify display plan 900. For example, user interface 820 may include a plurality of selectable display plan options 830 for modifying display plan 900. User interface 820 may allow a user to provide an input to processing circuit 210, and may also allow a user to provide display items 120 for display on personal electronic device 800 and/or display device 110. In some embodiments, processing circuit 210 is configured to change the display characteristic of at least one display item 120 based on display plan 900; display plan 900 may be received from personal electronic device 800.

In some embodiments, personal electronic device 800 includes a touchscreen, and a user may directly manipulate display characteristics of display items 120 through touch. For example, a user may input a touch to select display item 120, initiating replay of display items 120 based on the input. In some embodiments, personal electronic device 800 is configured to display user interface 820 in response to an input.

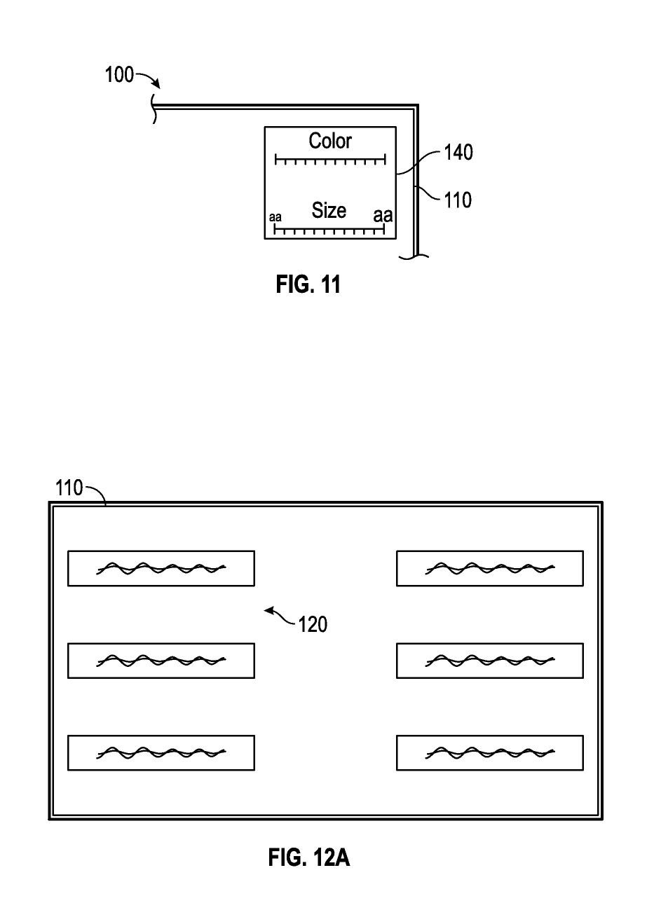

Referring to FIG. 11, display system 100 is shown with display device 110 configured to display user interface 140, in accordance with one embodiment. User interface 140 may include a plurality of selectable display plan options 150 for modifying display plan 900. User interface 140 may also allow a user to provide an input to processing circuit 210 (see FIG. 2).

As shown in FIG. 11, user interface 140 is provided in an upper-right corner of display device 110; however, in various embodiments, user interface 140 may be provided in various locations of display device 110. In some embodiments, user interface 140 is provided in a location of display device 110 lacking any display items 120. In some embodiments, processing circuit 210 is configured to modify display item positions 924 of display items 120 in order to provide an empty space for providing user interface 140. In some embodiments, processing circuit 210 is configured to provide user interface 140 in a location coincidental with display items 120. User interface 140 may be configured to become visible in response to certain inputs (e.g. a double tap in a predetermined location of display device 110, etc.).

In some embodiments, display device 110 is configured to display a plurality of display items 120. Processing circuit 210 is configured to store time data regarding a display time for each of the plurality of display items 120, receive an input identifying selected display item 120 from one of the plurality of display items 120, and change a display characteristic of at least one of the plurality of display items 120 based on the input and the time data.

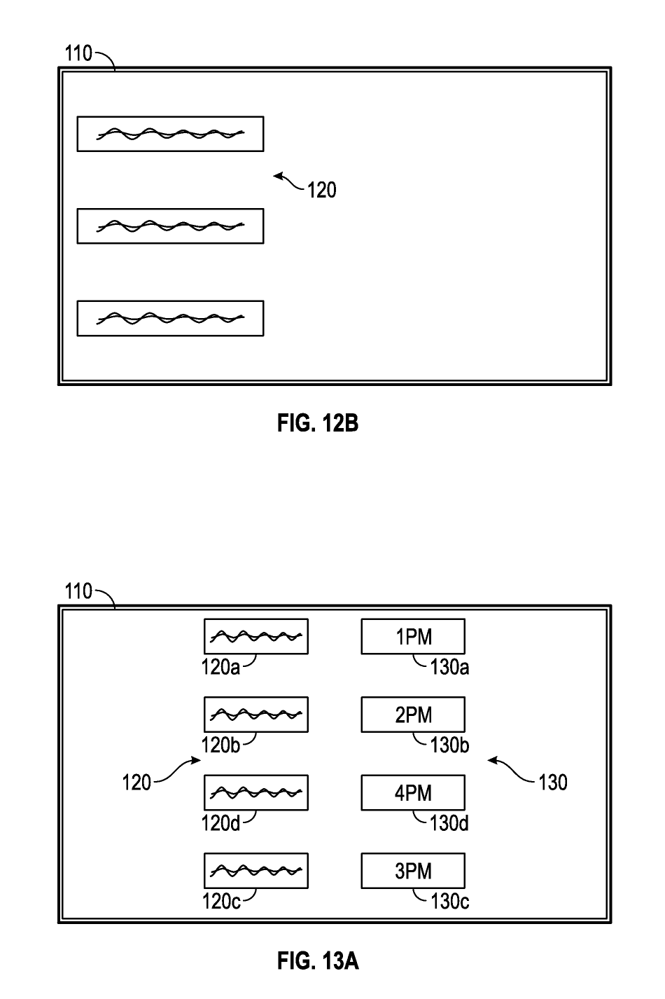

Referring to FIG. 12, in some embodiments, processing circuit 210 is configured to selectively change how a plurality of display items 120 is displayed based on an input. For example, an input may include selection of a subset of the plurality of display items 120. Processing circuit 210 may be configured to change visibility factor 922 of the subset of the plurality of display items 120 such that the subset becomes invisible. The input may be a single touch identifying one display item 120 of the plurality of display items 120, and processing circuit 210 may be configured to modify display of the plurality of display items 120 based on time data, or based on display characteristics showing relationships amongst the plurality of display items 120 (e.g. time windows, regions, etc.).

In some embodiments, processing circuit 210 is configured to change a first display characteristic of a first subset of the plurality of display items 120 to a first state, and change a second display characteristic of a second subset of the plurality of display items 120 to a second state different from the first state. For example, an input may identify selected display item 120. Color factor 923 of all display items having times of entry preceding the time of entry of selected display item 120 may be changed to a red state, while color factor 923 of all display items having times of entry following the time of entry of selected display item 120 may be changed to a blue state.

In some embodiments, display device 110 is configured to display a plurality of display items 120. Processing circuit 210 is configured to store time data regarding a display time for each of the plurality of display items 120, receive an input identifying selected display item 120 from one of the plurality of display items 120, and control operation of display device 110 to selectively display a portion of the plurality of display items 120 in a time-based order based on the input and the time data.

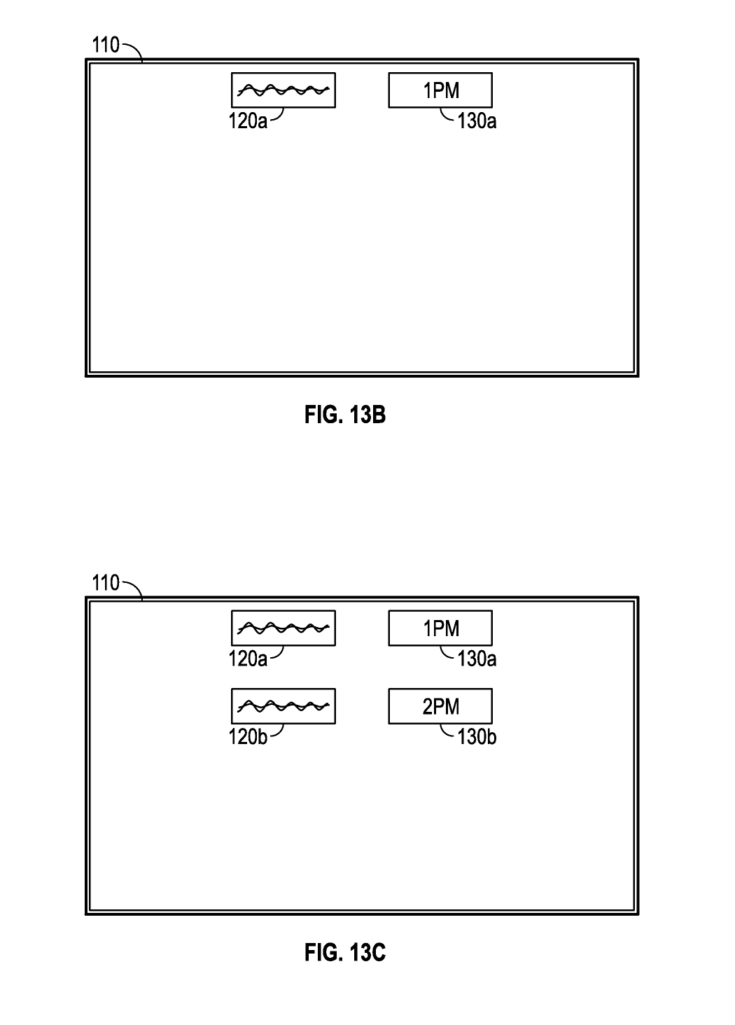

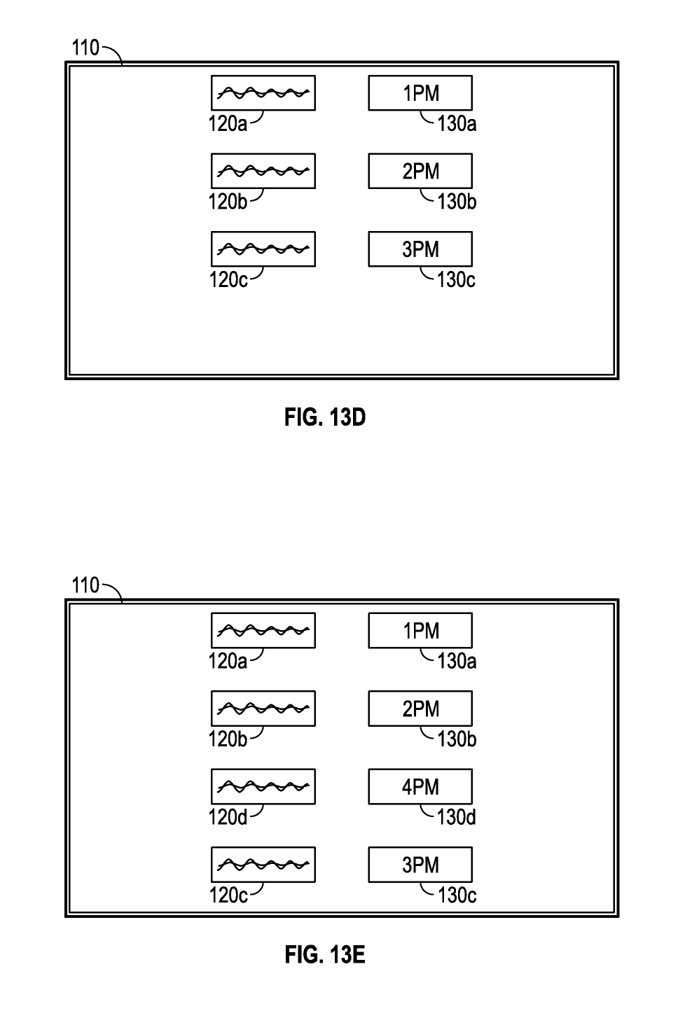

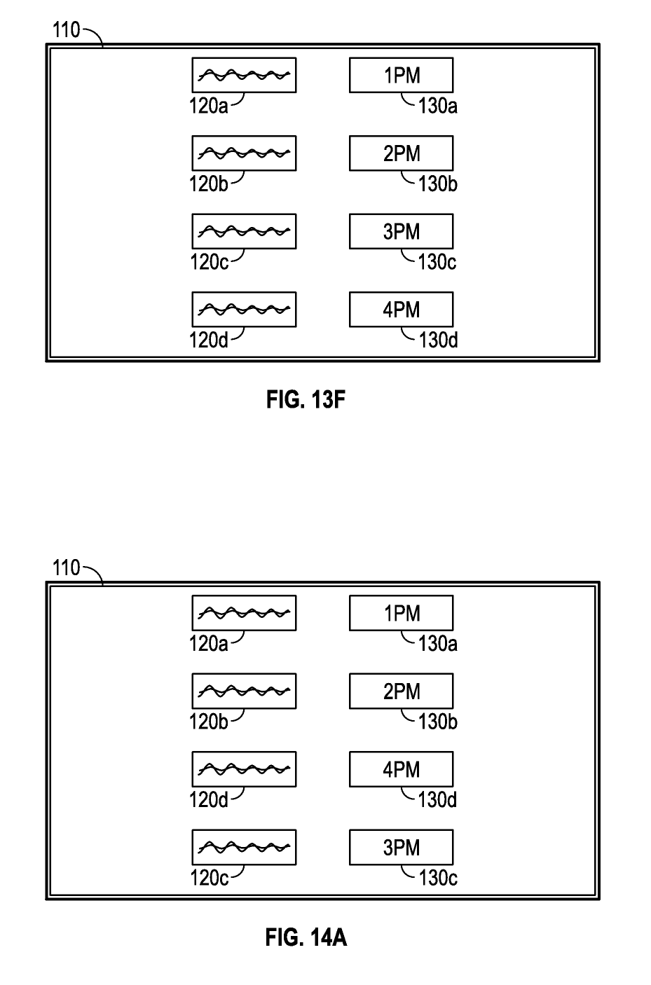

Referring to FIGS. 13A-13F, in some embodiments, processing circuit 210 is configured to control operation of display device 110 in order to display display items 120 in a chronological time-based order (“replay”). Referring to FIG. 13A, a plurality of display items 120a-120d having associated display time notes 130a-130d is shown. In response to an input, a chronological time-based order may be used to display display items 120, beginning with display item 120a having the earliest display time note 130a and proceeding in chronological order to end with display item 123d having the latest display time note 130d. In some embodiments, display items 120 are displayed in the time-based order while display time notes 130 are hidden or omitted from being displayed.

Referring to FIG. 13B, display item 120a, which has associated display time note 130a, is displayed. Referring to FIG. 13C, display item 120b, which has associated display time note 130b, is displayed in addition to preceding display item 120a. Referring to FIG. 13D, display item 120c, which has associated display time note 130c, is displayed in addition to preceding display items 120a-120b. Referring to FIG. 13E, in accordance with one embodiment, display item 120c is displayed such that its display item position 124 locates display item 120c between display item 120b and display item 120d, mimicking the display item positions 124 of display items 120a-120d before the replay was initiated. Referring to FIG. 13F, in other embodiments, display item 120c is displayed such that the relative display item positions 124 of display items 120a-120d correspond with the relative display time notes 130a-130d.

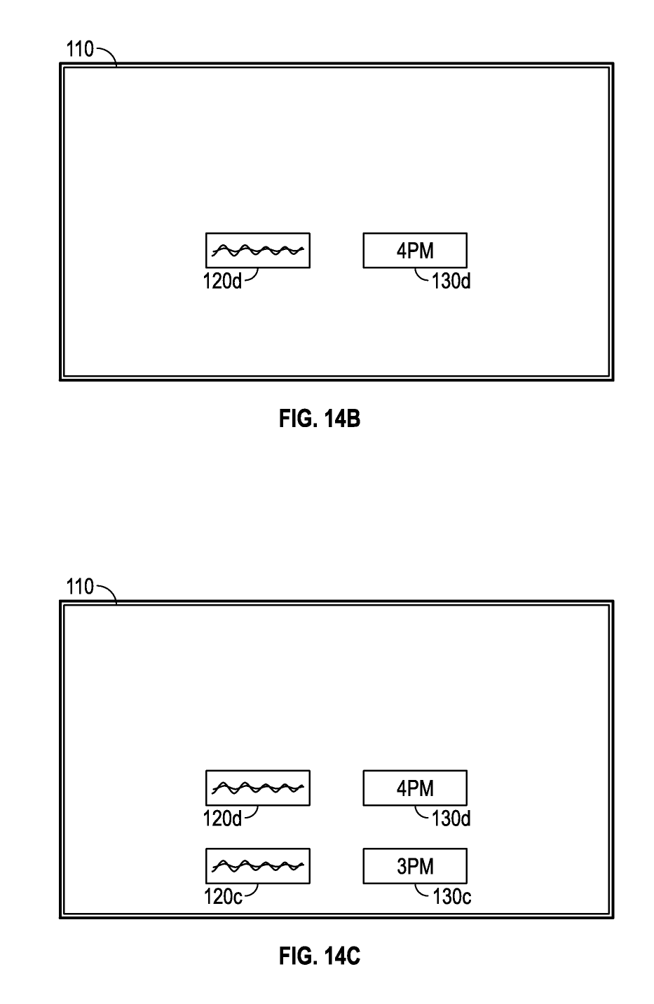

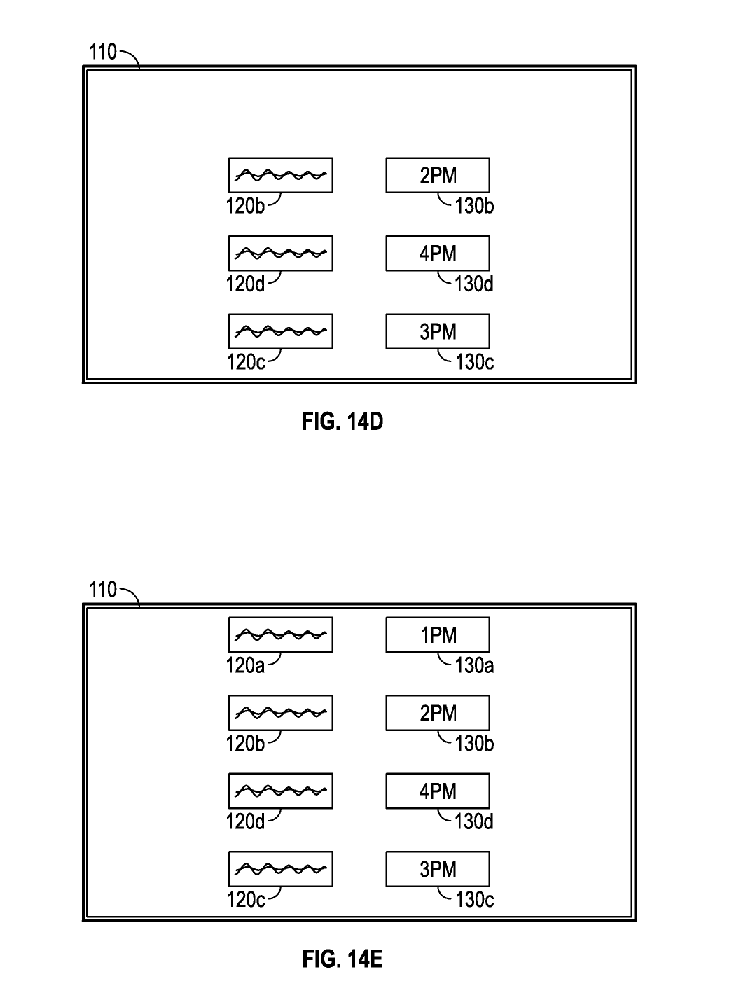

Referring to FIGS. 14A-14E, in some embodiments, processing circuit 210 is configured to control operation of display device 110 in order to display display items 120 in a reverse chronological time-based order (“reverse replay”). Referring to FIG. 14A, a plurality of display items 120a-120d having associated display time notes 130a-130d is shown. In response to an input, a reverse chronological time-based order may be used to display display items 120, beginning with display item 120d having the latest display time note 130d and proceeding in reverse chronological order to end with display item 120a having the earliest display time note 130a. In some embodiments, display items 120 are displayed in the reverse chronological time-based order while display item notes 130 are hidden or omitted from being displayed.

Referring to FIG. 14B, display item 120d having the latest display time note 130d is displayed. Referring to FIG. 14C, display item 120c, which has associated display time note 130c, is displayed in addition to previously displayed display item 120d. Referring to FIG. 14D, display item 120b, which has associated display time note 130b, is displayed in addition to previously displayed display items 120c-120d. Referring to FIG. 14E, display item 120a, which has earliest associated display time note 130a, is displayed in addition to previously displayed display items 120b-120d. In some embodiments, the reverse replay arranges display items 120a-120d such that their display item positions 124 correspond to their relative display item positions 124 prior to initiation of the reverse replay. In some embodiments, the reverse replay arranges display items 120a-120d such that their relative display item positions 124 correspond to display time notes 130a-130d.

In some embodiments, a replay or reverse replay takes place in which only one display item 120 is displayed at a time. In some embodiments, after a replay is completed, a portion of the plurality of display items 120 are erased; for example, all display items 120 except for selected display item 120 may be erased. In some embodiments, the replay takes place in a predetermined location different than the original location of display items 120, such as a corner of display device 110.

In some embodiments, processing circuit 210 is configured to control operation of display device 110 to display only a subset of the portion of display items 120 based on at least an input and a predetermined time window (e.g. time window 921 shown in FIG. 9) or time interval. For example, the input may identify selected display item 120 of the plurality of display items 120. Selected display item 120 may have time window 921 having an absolute value, and a subset of display items 120 may be determined as being those display items 120 having times of entry falling within time window 921 of the time of entry of selected display item 120. In some embodiments, a subset of display items 120 may be determined as being those display items 120 having times of entry falling within a specified time interval. A replay or reverse replay may then be performed in which only the subset of display items 120 are displayed in a time-based order.

In some embodiments, the time-based order includes a plurality of time gaps between each of consecutive sets of display items 120 displayed in the time-based order. For example, referring to the replay illustrated in FIGS. 13A-13F, a specific length of time (e.g. one second, 0.5 seconds, a real-time length of time corresponding to the length of time between times of entry of display items 120, etc.) may fall between when first display item 120a is displayed and when second display item 120b is displayed.

In some embodiments, the plurality of time gaps is based on a time gap input. The time gap input may be received from personal electronic device 800. For example, a user may provide a time gap input setting each time gap to a specific length of time. The time gaps may be of the same length of time, or may be of different lengths of time. For example, a user may provide a time gap input setting the duration of the replay, and processing circuit 210 may scale the individual time gaps so as to achieve the specified replay duration.

In some embodiments, a user may provide a time gap input corresponding to relative speed rates relative to a default time gap, or a time gap matching the lengths of time that occurred between times of entry of display items 120. For example, a default time gap may be set to one second, and a user may provide a “fast-forward” or “slow-down” time gap input modifying the time gap to a fraction of one second (for fast-forward mode) or a multiple of one second (for slow-down mode). In some embodiments, a time gap may be of infinite time (or a maximum time value significantly longer than a typical time gap), allowing a user to “pause” a replay or reverse replay.

Similarly, default time gaps may be set to the lengths of time that occurred between times of entry of display items 120, and a user may provide a time gap input relative to the lengths of time. For example, first display item 120a may have been entered at zero seconds, second display item 120b may have been entered at two seconds, and third display item 120c may have been entered at four seconds. During replay or reverse replay, if a user inputs a fast-forward command (e.g., to perform the replay at twice the speed of original entry of display items 120), then first display item 120a may be displayed at zero seconds, second display item 120b may be displayed at one second, and third display item 120c may be displayed at two seconds (relative to the start of the replay or reverse replay).

In some embodiments, processing circuit 210 may be configured to control operation of display device 110 to selectively display a portion of display items 120 based on a replay plan. The replay plan may include at least one of an input, a predetermined time window, and a time gap input. In some embodiments, the replay plan may be received from personal electronic device 800. In some embodiments, the replay plan may be used to modify properties of the replay, such as the time gap input, during a displaying of the portion of display items 120 in the time-based order. For example, personal device 800 may be configured to display a replay plan along with a plurality of selectable replay plan options 835 for modifying the replay plan. In some embodiments, personal electronic device 800 is configured to enable a user to modify the replay plan. A user may use personal electronic device 800 to manage the replay plan, and initiate a replay of a portion of the plurality of display items 120. During the replay, a user may modify the replay plan, for example, by changing the time gap input to a fast-forward mode, and processing circuit 210 may receive the replay plan from personal electronic device 800 and control operation of display device 110 to change the replay based on the replay plan. In some embodiments, the replay plan specifies whether the time-based order will be a chronological time-based order or a reverse chronological time-based order.

In some embodiments, processing circuit 210 is configured to modify the replay plan based on audio input. For example, processing circuit 210 may receive voice commands from a user providing instructions to identify selected display item 120, initiate a replay, modify a replay (e.g. by displaying display items 120 in fast-forward), etc.

In some embodiments, display device 110 is configured to display interactive user interface 140 including a plurality of selectable replay plan options 155 regarding the replay plan based on an input. For example, user interface 140 may include selectable replay plan options 155 regarding a time gap input, so that a user may select options such as initiating a replay, pausing a replay, fast-forwarding/slowing-down, etc., by interacting with user interface 140.

In some embodiments, display device 110 includes an electronic whiteboard. Display device 110 may be configured to be written on with ink-based markers. Display device 110 may be configured to be written on with an electronic marking device (e.g. electronic pen, stylus, touch device 240 shown in FIG. 2, etc.). Display device 110 may be configured to record display items 120 as they are received by display device 110, and to record times of entry of display items 120. Display device 100 may be configured to transmit records of display items 120 and times of entry of display items 120 to processing circuit 210. In some embodiments, display device 110 includes a touchscreen. Display device 110 may be configured to be written on with human touches. Display device 110 may be configured to be written on with an electronic marking device (e.g., electronic pen, stylus, touch device 240 shown in FIG. 2, etc.).

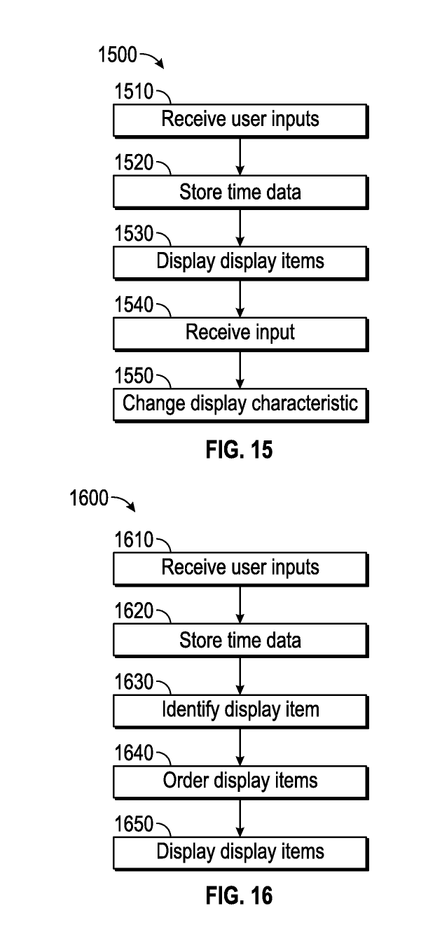

Referring to FIG. 15, method 1500 for displaying display items 120 on a display assembly (e.g. display device 110) is shown. At 1510, user inputs are received. User inputs may include display items 120. Display items 120 may include text in any language; images; symbols; graphics; charts; figures; or any other such information. Display items 120 may be received having display characteristics (e.g. size, color, font, etc.).

At 1520, time data regarding the user inputs is stored. For example, a processing circuit such as processing circuit 210 may be configured to store time data regarding display items 120. Time data may include any temporal information associated with display items 120, such as times of entry, relative times of entry, times associated with operation of the display assembly, times associated with calendars or schedules, etc. Display characteristics may be stored along with time data.

At 1530, display items 120 are displayed. Display items 120 may be displayed based on the user inputs using default display characteristics. A user interface, such as user interface 140, may be used to enable a user to manipulate a plurality of selectable user options 150 to determine display characteristics for display items 120. For example, display items 120 may be displayed having color factor 923 set to a black color as a default color state; a user may manipulate selectable user option 150 relating to color factor 923 in order to change color factor 923 to a different color state, such as blue.

At 1540, an identifying input is received. The input may be a manual touch; a touch with a handheld implement such as a pen or other item configured to provide touch input to a display assembly; a visual input such as a signal from anywhere in the electromagnetic spectrum, a gesture, or a gaze; an electronic input such as a command transmitted by wireless connection, wired connection, Bluetooth, or any other electronic communications protocol; an audio input; or any other input. In some embodiments, the input identifies display item 120.

At 1550, a display characteristic of display item 120 is changed. For example, processing circuit 210 may be configured to change display of display item 120 based on the input and time data associated with display items 120 by coloring all display items with times of entry previous to selected display item 120 with a first color, and all display items 120 with times of entry subsequent to selected display item 120 with a second color.

Referring to FIG. 16, method 1600 of displaying display items 120 in a time-based order is shown. At 1610, user inputs are received. User inputs may include display items 120. Display items 120 may include text in any language; images; symbols; graphics; charts; figures; or any other such information. Display items 120 may be received having display characteristics (e.g. size, color, font, etc.).

At 1620, time data regarding user inputs is stored. For example, processing circuit 210 may be configured to store time data regarding display items 120. Time data may include any temporal information associated with display items 120, such as times of entry, relative times of entry, times associated with operation of the display assembly, times associated with calendars or schedules, etc. Display characteristics may be stored along with time data.

At 1630, selected display item 120 is identified. Selected display item 120 may be identified by an input, including direct inputs, such as manual touches including touches by fingers or other body parts; assisted touches, such as touches by pens or other handheld implements; as well as indirect inputs, such as audio inputs, light-based inputs (e g infrared, laser, visible light, radio, etc.), gestures, gazes, and electronic inputs (e.g. from a personal electronic device such as personal electronic device 800, etc.).

At 1640, a time-based order is determined for display items 120 based on identification of selected display item 120. The time-based order may be chronological, beginning with display item 120 having the earliest time of entry and proceeding in order to display item 120 having the latest time of entry. The time-based entry may be reverse chronological, beginning with display item 120 having the latest time of entry and proceeding in order to display item 120 having the earliest time of entry. The time-based order may include time gaps interspersed between consecutive pairs of display items 120 to determine the timing of display of display items 120. In some embodiments, a replay plan including at least one of an input, a predetermined time window, and a time gap input is used to determine the time-based order.

At 1650, display items 120 are displayed in the time-based order. A display plan (e.g. display plan 900 shown in FIG. 9) may be used to determine display characteristics of display items 120 when they are displayed. In some embodiments, display items 120 are displayed in the time-based order in a manner identical to how display items 120 were originally received. For example, display items 120 may be displayed with same display item positions 124, and the same length of time between entry of display items 120.

In some embodiments, display items 120 are displayed with different display item positions 124. Display items 120 may be displayed with relative display item positions 124 modified to reflect various spatial ordering goals (e.g., display items 120 may have relative display item positions 124 ordered to match the time-based order, etc.).

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A display system, comprising:
a display device configured to display a first display item based on receiving a first input and display a second display item based on receiving a second input; and
a processing circuit configured to:
store first time data corresponding to a first time of receipt of the first input;
store second time data corresponding to a second time of receipt of the second input;
receive a third input identifying at least one of the first display item and the second display item; and
change a display characteristic of at least one of the first display item and the second display item based on the third input, the first time data, and the second time data.

2. The display system of claim 1, wherein the third input identifies the first display item, and wherein the processing circuit is further configured to select a target time based on the first time data.

3. The display system of claim 2, wherein the processing circuit is further configured to change a display characteristic of the first display item.

4. The display system of claim 2, wherein the processing circuit is further configured to determine a time interval based on the target time and a predetermined time window.

5-9. (canceled)

10. The display system of claim 1, wherein the processing circuit is further configured to:
determine a time difference based on the first time of receipt and the second time of receipt; and
change the display characteristic further based on the time difference and a predetermined time window.

11-12. (canceled)

13. The display system of claim 1, wherein the display characteristic includes a visibility factor including at least one of a visible state and an invisible state.

14-17. (canceled)

18. The display system of claim 1, wherein the display characteristic includes an apparent size factor.

19-20. (canceled)

21. The display system of claim 1, wherein the display device is further configured to display at least the first display item in a three-dimensional format.

22. The display system of claim 1, wherein the display characteristic includes a brightness factor.

23-24. (canceled)

25. The display system of claim 1, wherein the display characteristic includes a highlight factor.

26-28. (canceled)

29. The display system of claim 1, wherein the display characteristic includes a region.

30-32. (canceled)

33. The display system of claim 1, wherein the third input is a touch on a visual representation of the display device displayed on a personal electronic device.

34-42. (canceled)

43. A display system, comprising:
a display device configured to display a plurality of display items; and
a processing circuit configured to:
store time data regarding a display time for each of the plurality of display items;
receive an input identifying a selected display item from one of the plurality of display items; and
change a display characteristic of at least one of the plurality of display items based on the input and the time data.

44. The display system of claim 43, wherein the processing circuit is further configured to select a target time based on the display time of the selected display item.

45. (canceled)

46. The display system of claim 44, wherein the processing circuit is further configured to:
determine a time difference between the target time and the display time of at least one of the plurality of display items; and
change a display characteristic of the display item based on at least one of a magnitude and a sign of the time difference.

47-48. (canceled)

49. The display system of claim 43, wherein the processing circuit is further configured to change a first display characteristic of a first subset of the plurality of display items to a first state, and to change a second display characteristic of a second subset of the plurality of display items to a second state different from the first state.

50-52. (canceled)

53. The display system of claim 43, wherein the display characteristic includes a color factor.

54. (canceled)

55. The display system of claim 43, wherein the display characteristic includes an objective size factor.

56-59. (canceled)

60. The display system of claim 43, wherein the display device is further configured to display at least one of the plurality of display items in a three-dimensional format.

61-64. (canceled)

65. The display system of claim 43, wherein the processing circuit is further configured to control operation of the display device to display a time note corresponding to the display time of at least one of the plurality of display items.

66. The display system of claim 43, wherein the display characteristic includes a position state.

67. The display system of claim 43, wherein the display characteristic includes a region.

68-70. (canceled)

71. The display system of claim 43, wherein the input is a touch on a visual representation of the display device displayed on a personal electronic device.

72-77. (canceled)

78. The display system of claim 43, wherein the display device is an electronic whiteboard.

79. (canceled)

80. A display system, comprising:
a display device configured to display a plurality of display items; and
a processing circuit configured to:
store time data regarding a display time for each of the plurality of display items;
receive an input identifying a selected display item from one of the plurality of display items; and
control operation of the display device to selectively display a portion of the plurality of display items in a time-based order based on the input and the time data.

81. The display system of claim 80, wherein the processing circuit is further configured to select a target time based on the display time of the selected display item.

82. The display system of claim 81, wherein the processing circuit is configured to selectively display a portion of the plurality of display items in a time-based order based on the target time and the time data.

83. The display system of claim 81, wherein the processing circuit is further configured to:
determine a time different between the target time and the display time of at least one of the plurality of display items; and
selectively display a portion of the plurality of display items in a time-based order based on at least one of a magnitude and a sign of the time difference.

84-85. (canceled)

86. The display system of claim 80, wherein the processing circuit is further configured to determine the time-based order as a chronological order beginning with a display item of the portion of display items having an earliest display time and ending with a display item of the portion of display items having a latest display time.

87-88. (canceled)

89. The display system of claim 80, wherein the processing circuit is further configured to determine the time-based order as a reverse chronological order beginning with a display item of the portion of items having a latest display time and ending with a display item of the portion of display items having an earliest display time.

90-91. (canceled)

92. The display system of claim 80, wherein the processing circuit is further configured to control operation of the display device to display only a subset of the portion of display items based on at least the input and a predetermined time window.

93. The display system of claim 80, wherein the time-based order includes a plurality of time gaps between each of consecutive sets of display items displayed in the time-based order.

94-96. (canceled)

97. The display system of claim 80, wherein the processing circuit is further configured to control operation of the display device to selectively display the portion of display items based on a replay plan.

98. The display system of claim 97, wherein the replay plan includes at least one of the input, a predetermined time window, and a time gap input.

99-104. (canceled)

105. The display system of claim 80, wherein the display device includes a touchscreen.

106-210. (canceled)
